(19) United States
(12) Patent Application Publication
(10) Pub. No.: US 2026/0360292 A1
(43) Pub. Date: Nov. 12, 2026

(54) DISPLAY APPARATUS AND ELECTRONIC APPARATUS INCLUDING THE SAME

(71) Applicant: Samsung Display Co., Ltd., Yongin-Si (KR)

(72) Inventors: YOUNGWOON CHOI, Yongin-si (KR); NAMJAE LIM, Yongin-si (KR); SUNGJAE PARK, Yongin-si (KR); SEUNGHO PARK, Yongin-si (KR)

(21) Appl. No.: 19/658,788

(22) Filed: Apr. 27, 2026

(30) Foreign Application Priority Data
May 9, 2025 (KR) 10-2025-0060222

(51) Int. Cl. G09G 3/20

(52) U.S. Cl. CPC G09G 3/2007; G09G 2320/0257; G09G 2320/046; G09G 2320/06; G09G 2330/021; G09G 2330/04

(57) ABSTRACT

A display apparatus includes a data driver outputting a data voltage to a display panel, a power generator outputting a power to the display panel or the data driver, a driving controller controlling the data driver and the power generator and a current sensor sensing a current of the display panel. The current controller receives an input value, a sensed current, a second scale factor, and outputs a target current and a first scale factor to the shut down controller and an output value by applying the second scale factor to the input value. The shut down controller generates a protection level corresponding to the target current, the second scale factor based on the first scale factor and a comparison signal generated by comparing the protection level and the sensed current and outputs a shut down signal based on the comparison signal and a count signal.

### PRIORITY STATEMENT

This application claims priority under 35 U.S.C. § 119 to Korean Patent Application No. 10-2025-0060222, filed on May 9, 2025, in the Korean Intellectual Property Office KIPO, the contents of which are herein incorporated by reference in their entireties.

### BACKGROUND

### 1. Field

Embodiments of the present disclosure relate to a display apparatus and an electronic apparatus including the display apparatus. More particularly, embodiments of the present disclosure relate to a display apparatus preventing a burn-in of a display panel based on a sensed current and an electronic apparatus including the display apparatus.

### 2. Description of the Related Art

Generally, a display apparatus includes a display panel and a display panel driver. The display panel displays an image based on input image data. The display panel includes a plurality of gate lines, a plurality of data lines and a plurality of pixels. The display panel driver includes a gate driver, a data driver, a driving controller and a power generator. The gate driver outputs gate signals to the gate lines. The data driver outputs data voltages to the data lines. The driving controller controls an operation of the gate driver and an operation of the data driver. The power generator outputs a power voltage to the display panel and the data driver.

In a conventional display apparatus, a protection operation of a display apparatus may operate based on a black overcurrent protection level and a maximum overcurrent protection level so that protection performance may be poor for patterns other than a black pattern and a full white pattern. For example, in the conventional display apparatus, a burn-in occurring in a low load pattern may not be properly detected so that the display apparatus may be damaged.

### SUMMARY

Embodiments of the present disclosure provide a display apparatus enhancing a protection performance by operating a protection operation based on a protection level which is determined based on a target current in an entire grayscale value range.

Embodiments of the present inventive concept also provide an electronic apparatus including the display apparatus.

In an embodiment of a display apparatus according to the present disclosure, the display apparatus may include a display panel, a data driver, a power generator, a driving controller and a current sensor. The data driver may be configured to output a data voltage to the display panel. The power generator may be configured to output a power voltage to the display panel or the data driver. The driving controller may be configured to control the data driver and the power generator and may comprise a current controller and a shut down controller. The current sensor may be configured to sense a current of the display panel. The current controller may be configured to receive an input grayscale value and a sensed current sensed by the current sensor, and output a target current and a first scale factor to the shut down controller, and receive a second scale factor from the shut down controller and output an output grayscale value by applying the second scale factor to the input grayscale value. The shut down controller may be configured to generate a protection level corresponding to the target current, and generate the second scale factor based on the first scale factor and a comparison signal generated by comparing the protection level and the sensed current and to output a shut down signal based on the comparison signal and a count signal.

In an embodiment, the current controller may include a target current determiner configured to generate the target current based on the input grayscale value.

In an embodiment, the current controller may further include a scale factor determiner configured to generate the first scale factor based on the sensed current and the target current.

In an embodiment, the shut down controller may include a protection level determiner configured to determine the protection level based on the target current.

In an embodiment, the protection level may be determined by multiplying the target current by a first constant and adding a black overcurrent protection level.

In an embodiment, the shut down controller may further include a comparator configured to generate the comparison signal by comparing the sensed current and the protection level.

In an embodiment, the shut down controller may further include a first controller configured to generate the second scale factor based on the comparison signal and the first scale factor.

In an embodiment, when the sensed current is less than the protection level, the controller may be configured to generate the first scale factor as the second scale factor.

In an embodiment, the first controller may be configured to generate the second scale factor which is less than the first scale factor and to increase the count signal when the sensed current is equal to or greater than the protection level.

In an embodiment, the first controller may be configured to output the shut down signal to the power generator when the count signal is equal to or greater than a threshold count.

In an embodiment, the current controller may further include a multiplier configured to apply the second scale factor to the input grayscale value to generate the output grayscale value.

In an embodiment, the shut down controller may further include an escape level determiner configured to generate a protection escape level based on the target current.

In an embodiment, the protection escape level may be greater than the target current and less than the protection level.

In an embodiment, the shut down controller may further include a second comparator configured to generate a second comparison signal by comparing the sensed current and the protection escape level.

In an embodiment, the shut down controller may further include the first controller configured to generate the second scale factor based on the comparison signal, the second comparison signal and the first scale factor.

In an embodiment, the display apparatus may be configured to enter a protection mode when the sensed current is equal to or greater than the protection level. The protection mode of the display apparatus may be maintained when the sensed current is less than the protection level and equal to or greater than the protection escape level after entering the protection mode. The display apparatus may be configured to escape from the protection mode when the sensed current is less than the protection escape level after entering the protection mode.

In an embodiment, when the display apparatus operates in the protection mode, the controller may be configured to generate the second scale factor which is less than the first scale factor and to increase the count signal. When the display apparatus operates in a normal mode which is not the protection mode, the controller may be configured to generate the first scale factor as the second scale factor and to initialize the count signal to an initialization value.

In an embodiment, the driving controller may further include a grayscale value accumulator configured to accumulate the input grayscale value to generate a grayscale value accumulation signal. As a value of the grayscale value accumulation signal increases, the scale factor determiner may be configured to decrease the first scale factor of a low grayscale value range.

In an embodiment, the driving controller may further include a grayscale value accumulator configured to accumulate the output grayscale value to generate a grayscale value accumulation signal. As a value of the grayscale value accumulation signal increases, the scale factor determiner may be configured to decrease the first scale factor of a low grayscale value range.

In an embodiment of an electronic apparatus according to the present inventive concept, the electronic apparatus may include a display panel, a data driver, a power generator, a driving controller, a current sensor and a processor. The data driver may be configured to output a data voltage to the display panel. The power generator may be configured to output a power voltage to the display panel or the data driver. The driving controller may be configured to control the data driver and the power generator and comprising a current controller and a shut down controller. The current sensor may be configured to sense a current of the display panel. On or more processors may be configured to output input image data and an input control signal to the driving controller. The current controller is configured to receive an input grayscale value and a sensed current sensed by the current sensor, and output a target current and a first scale factor to the shut down controller, and receive a second scale factor from the shut down controller and output an output grayscale value by applying the second scale factor to the input grayscale value. The shut down controller is configured to generate a protection level corresponding to the target current, and generate the second scale factor based on the first scale factor and a comparison signal generated by comparing the protection level and the sensed current, and output a shut down signal based on the comparison signal and a count signal.

According to the display apparatus and the electronic apparatus including the display apparatus, the protection level may be determined based on the target current in the entire grayscale value range of the input image data and the protection operation may be operated based on the protection level so that the protection performance may be enhanced.

The burn-in occurring in the entire load pattern may be properly detected so that the display apparatus may not be damaged.

### BRIEF DESCRIPTION OF THE DRAWINGS

The above and other features and advantages of the present inventive concept will become more apparent by describing in detailed embodiments thereof with reference to the accompanying drawings.

FIG. 1 is a block diagram illustrating a display apparatus according to an embodiment of the present inventive concept.

FIG. 2 is a block diagram illustrating a current sensor, a driving controller and a power generator of the display apparatus of FIG. 1.

FIG. 3 is a detailed block diagram illustrating the current sensor, the driving controller and the power generator of the display apparatus of FIG. 1.

FIG. 4A is a graph illustrating a protection operation according to a comparative embodiment.

FIG. 4B is a graph illustrating a protection operation of the display apparatus of FIG. 1.

FIG. 5 is a detailed block diagram illustrating a current sensor, a driving controller and a power generator of a display apparatus according to an embodiment of the present inventive concept.

FIG. 6 is a detailed block diagram illustrating a current sensor, a driving controller and a power generator of a display apparatus according to an embodiment of the present inventive concept.

FIG. 7 is a detailed block diagram illustrating a current sensor, a driving controller and a power generator of a display apparatus according to an embodiment of the present inventive concept.

FIG. 8 is a block diagram illustrating an electronic apparatus according to an embodiment of the present inventive concept.

FIG. 9 is a diagram illustrating an example in which the electronic apparatus of FIG. 8 is implemented as a television.

FIG. 10 is a diagram illustrating an example in which the electronic apparatus of FIG. 8 is implemented as a monitor.

FIG. 11 is a diagram illustrating an example in which the electronic apparatus of FIG. 8 is implemented as a smartphone.

FIG. 12 is a block diagram illustrating an electronic apparatus according to an embodiment of the present inventive concept.

FIG. 13 is schematic diagrams illustrating the electronic apparatuses of FIG. 12.

### DETAILED DESCRIPTION OF THE INVENTIVE CONCEPT

Hereinafter, the present inventive concept will be explained in detail with reference to the accompanying drawings.

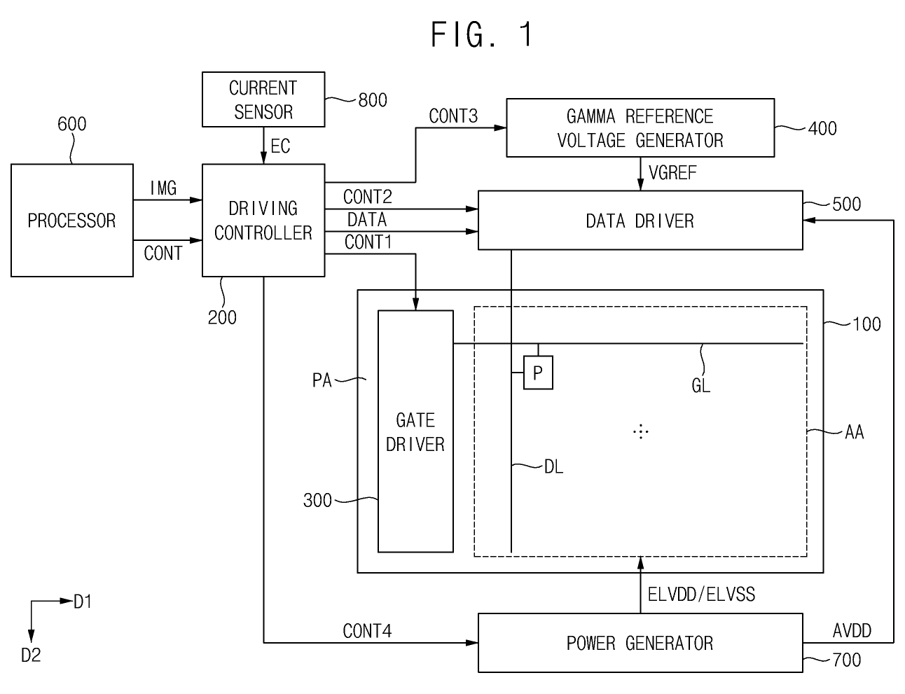

FIG. 1 is a block diagram illustrating a display apparatus according to an embodiment of the present inventive concept.

Referring to FIG. 1, the display apparatus includes a display panel 100 and a display panel driver. The display panel driver drives the display panel 100. The display panel driver includes a driving controller 200, a gate driver 300, a gamma reference voltage generator 400, a data driver 500 and a power generator 700. The display panel driver may further include a current sensor 800.

The display panel driver may further include a processor 600. The processor 600 may be defined as an internal element of the display apparatus. In an embodiment the processor 600 may be defined as an external element of the display apparatus. When the processor 600 is the external element of the display apparatus, an electronic apparatus may include the display panel 100, the display panel driver and the processor 600.

The display panel 100 has a display region AA on which an image is displayed and a peripheral region PA adjacent to the display region AA.

The display panel 100 includes a plurality of gate lines GL, a plurality of data lines DL and a plurality of pixels P connected to the gate lines GL and the data lines DL. The gate lines GL may extend in a first direction D1 and the data lines DL may extend in a second direction D2 crossing the first direction D1.

The driving controller 200 receives input image data IMG and an input control signal CONT from an external apparatus (e.g. the processor 600). For example, the input image data IMG may include red image data, green image data and blue image data. For example, the input image data IMG may include white image data. For example, the input image data IMG may include magenta image data, yellow image data and cyan image data. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, a third control signal CONT3, a fourth control signal CONT4 and a data signal DATA based on the input image data IMG and the input control signal CONT.

The driving controller 200 generates the first control signal CONT1 for controlling an operation of the gate driver 300 based on the input control signal CONT, and outputs the first control signal CONT1 to the gate driver 300. The first control signal CONT1 may include a vertical start signal and a gate clock signal.

The driving controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG. The driving controller 200 outputs the data signal DATA to the data driver 500.

The driving controller 200 generates the third control signal CONT3 for controlling an operation of the gamma reference voltage generator 400 based on the input control signal CONT, and outputs the third control signal CONT3 to the gamma reference voltage generator 400.

The driving controller 200 generates the fourth control signal CONT4 for controlling an operation of the power generator 700 based on the input control signal CONT, and outputs the fourth control signal CONT4 to the power generator 700.

The gate driver 300 generates gate signals driving the gate lines GL in response to the first control signal CONT1 received from the driving controller 200. The gate driver 300 outputs the gate signals to the gate lines GL. For example, the gate driver 300 may sequentially output the gate signals to the gate lines GL. For example, the gate driver 300 may be mounted on the peripheral region PA of the display panel 100. For example, the gate driver 300 may be integrated on the peripheral region PA of the display panel 100.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500.

In an embodiment, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages having an analog type using the gamma reference voltages VGREF. The data driver 500 outputs the data voltages to the data lines DL.

The power generator 700 outputs a power voltage to the display panel 100 or the data driver 500. The power generator 700 may generate a first power voltage ELVDD, a second power voltage ELVSS and a data power voltage AVDD in response to the fourth control signal CONT4 received from the driving controller 200. The power generator 700 may output the first power voltage ELVDD and the second power voltage ELVSS to the display panel 100. The power generator 700 may output the data power voltage AVDD to the data driver 500.

The current sensor 800 may sense a current of the display panel 100. For example, the current sensor 800 may sense the current of the display panel 100 by sensing the first power voltage ELVDD output from the power generator 700 to the display panel 100.

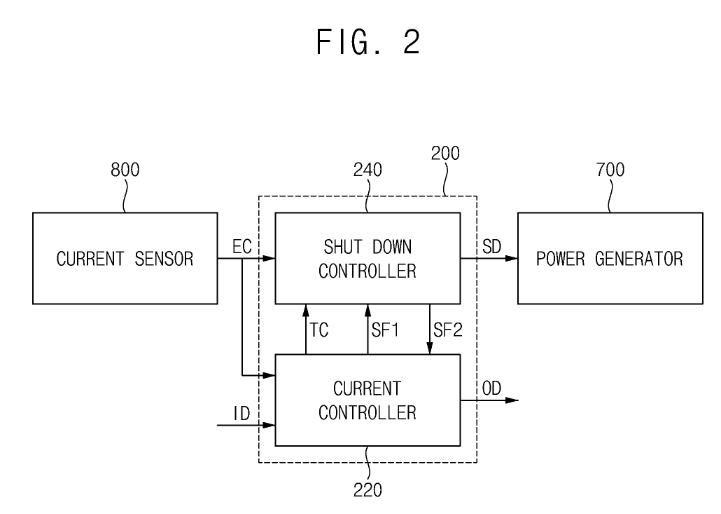

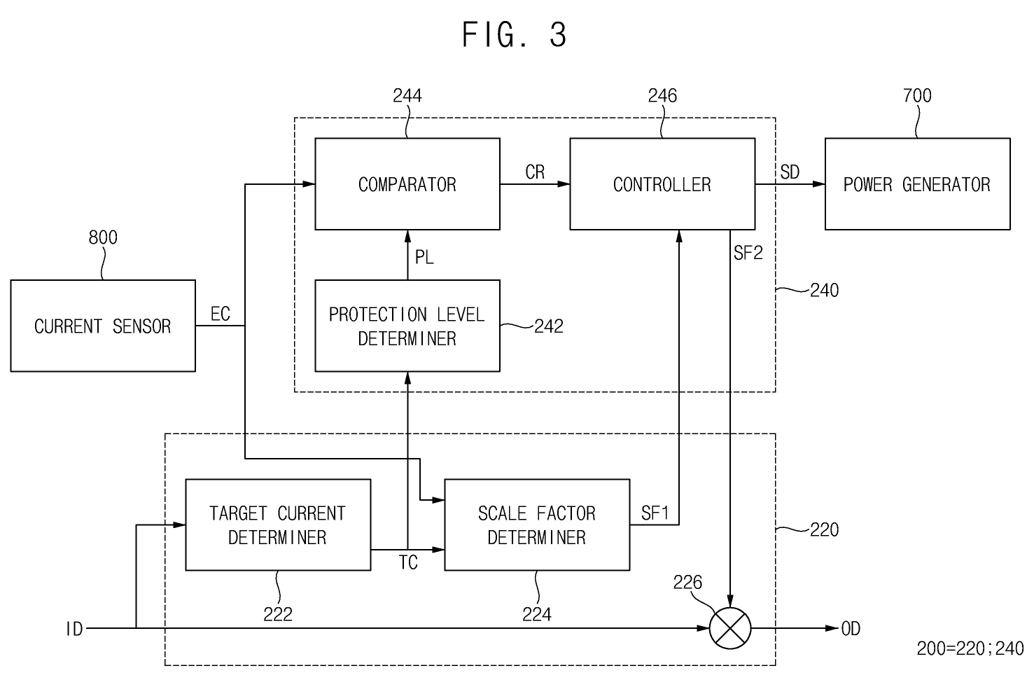

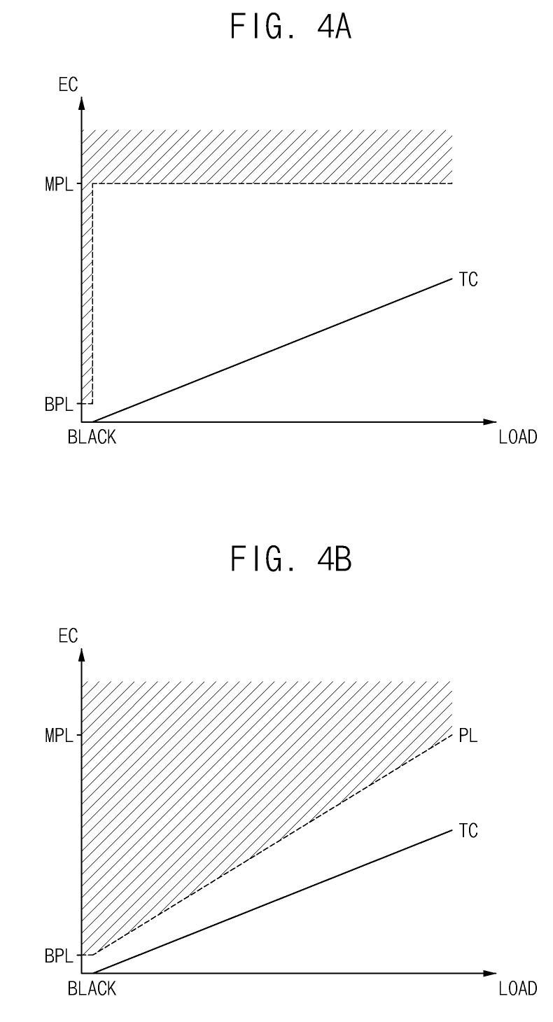

FIG. 2 is a block diagram illustrating the current sensor 800, the driving controller 200 and the power generator 700 of the display apparatus of FIG. 1. FIG. 3 is a detailed block diagram illustrating the current sensor 800, the driving controller 200 and the power generator 700 of the display apparatus of FIG. 1. FIG. 4A is a graph illustrating a protection operation according to a comparative embodiment. FIG. 4B is a graph illustrating a protection operation of the display apparatus of FIG. 1.

Referring to FIGS. 1 - 4B, the driving controller 200 includes a current controller 220 and a shut down controller 240.

The current controller 220 may receive an input grayscale value ID and a sensed current EC sensed by the current sensor 800 and may output a target current TC and a first scale factor SF1 to the shut down controller 240.

The current controller 220 may receive a second scale factor SF2 from the shut down controller 240 and may output an output grayscale value OD by applying the second scale factor SF2 to the input grayscale value ID.

The shut down controller 240 may generate a protection level PL corresponding to the target current TC. The shut down controller 240 may generate the second scale factor SF2 based on the first scale factor SF1 and a comparison signal CR generated by comparing the protection level PL and the sensed current EC and may output a shut down signal SD based on the comparison signal CR and a count signal.

For example, the current controller 220 may include a target current determiner 222 generating the target current TC based on the input grayscale value ID. Herein, the target current TC may be the target current TC of the entire panel, not the target current TC of one pixel. The target current determiner 222 may accumulate the input grayscale values ID of all pixels to generate the target current TC.

For example, the current controller 220 may further include a scale factor determiner 224 generating the first scale factor SF1 based on the sensed current EC and the target current TC.

For example, when the sensed current EC is equal to or less than the target current TC, the scale factor determiner 224 may not operate a scaling operation. For example, when the sensed current EC is equal to or less than the target current TC, the scale factor determiner 224 may generate the first scale factor SF1 of one.

The first scale factor SF1 may be a value between zero and one and the first scale factor SF1 may be multiplied to the input grayscale value ID to generate the output grayscale value OD.

For example, when the sensed current EC is greater than the target current TC, the scale factor determiner 224 may operate the scaling operation. For example, when the sensed current EC is greater than the target current TC, the scale factor determiner 224 may generate the first scale factor SF1 of a value less than one.

The scale factor determiner 224 may output the first scale factor SF1 to a controller 246 of the shut down controller 240.

For example, the shut down controller 240 may include a protection level determiner 242 determining the protection level PL based on the target current TC.

The protection level PL may be determined by multiplying the target current TC by a first constant and adding a black overcurrent protection level BPL.

For example, the first constant may be a value greater than one. For example, the first constant may be 1.3.

For example, the shut down controller 240 may further include a comparator 244 generating the comparison signal CR by comparing the sensed current EC and the protection level PL.

For example, the comparison signal CR may have a type of a flag. For example, when the sensed current EC is less than the protection level PL, the comparison signal CR may be zero. For example, when the sensed current EC is equal to or greater than the protection level PL, the comparison signal CR may be one.

For example, the shut down controller 240 may further include the controller 246 generating the second scale factor SF2 based on the comparison signal CR and the first scale factor SF1.

Like the first scale factor SF1, the second scale factor SF2 may be a value between zero and one and the second scale factor SF2 may be used to be multiplied to the input grayscale value ID to generate the output grayscale value OD.

When the sensed current EC is less than the protection level PL, the controller 246 may generate the first scale factor SF1 as the second scale factor SF2. For example, when the sensed current EC is less than the protection level PL, the display apparatus may operate in a normal mode, not in a protection mode. In the normal mode, the controller 246 may initialize the count signal to an initialization value.

When the sensed current EC is equal to or greater than the protection level PL, the controller 246 may generate the second scale factor SF2 which is less than the first scale factor SF1 and may increase the count signal. When the sensed current EC is equal to or greater than the protection level PL, the display apparatus may operate in the protection mode.

In the present embodiment, in the protection mode, the controller 246 does not immediately output the shut down signal SD to the power generator 700.

In the protection mode, the controller 246 lowers the first scale factor SF1 to the second scale factor SF2 and outputs the second scale factor SF2 to the current controller 220. When the current controller 220 operates the scaling operation based on the second scale factor SF2 less than the first scale factor SF1, it means that a degree of scaling increases.

When entering the protection mode, the controller 246 may accelerate the scaling operation of the current controller 220 so that a current of the display panel 100 may be rapidly reduced and a counting operation which increases the count signal may start.

When the sensed current EC received from the current sensor 800 continues to be equal to or greater than the target current TC for a predetermined time period despite the acceleration of the scaling operation, the controller 246 may output the shut down signal SD to the power controller 700. For example, when the count signal is equal to or greater than a threshold count (corresponding to the predetermined time period), the controller 246 may output the shut down signal SD to the power generator 700.

When the power generator 700 receives the shut down signal SD, the power generator 700 may rapidly reduce a level of the first power voltage ELVDD to stop a light emission of the display panel 100.

When the power generator 700 receives the shut down signal SD, the power generator 700 may rapidly reduce a level of the data power voltage AVDD to stop an operation of the data driver 500.

The current controller 220 may further include a multiplier 226 applying the second scale factor SF2 to the input grayscale value ID to generate the output grayscale value OD.

FIG. 4A represents a protection operation according to the comparative embodiment and FIG. 4B represents a protection operation of the display apparatus of FIG. 1. In FIGS. 4A and 4B, LOAD means a load of the input image data IMG and may correspond to the entire display panel 100. The LOAD may be a load of the input image data IMG corresponding to one frame. For example, the LOAD may be calculated by accumulating the grayscale values of the input image data IMG corresponding to the entire display panel 100 and raising the accumulated grayscale values to a power of the gamma value (e.g. 2.2).

As shown in FIG. 4A, when the input image data IMG represent a black pattern (LOAD=0) in the conventional display apparatus, whether the sensed current EC is greater than the black overcurrent protection level BPL. When the input image data IMG represent the black pattern (LOAD=0) and the sensed current EC is greater than the black overcurrent protection level BPL in the conventional display apparatus, the power generator 700 may output the shut down signal SD.

In contrast, when the input image data IMG do not represent the black pattern (LOAD=0) in the conventional display apparatus, whether the sensed current EC is greater than a maximum overcurrent protection level MPL. When the input image data IMG do not represent the black pattern (LOAD=0) and the sensed current EC is greater than the maximum overcurrent protection level MPL in the conventional display apparatus, the power generator 700 may output the shut down signal SD.

In the conventional display apparatus, a protection performance may be poor for patterns other than a black pattern and a full white pattern. For example, in the conventional display apparatus, a burn-in (burnt) occurring in a low load pattern may not be properly detected so that the display apparatus may be damaged. The burn-in may mean that the display panel is burned by fire.

As shown in FIG. 4B, the protection levels PL may be set corresponding to various loads of the input image data IMG as well as corresponding to a black pattern (LOAD=0) and a full white pattern.

Thus, in the display apparatus of the present embodiment, the protection performance may be enhanced for patterns except for the black pattern and the full white pattern. For example, the damage of the display apparatus due to the burn-in occurring in the low load pattern and not properly detected may be prevented.

According to the present embodiment, the protection level PL may be determined based on the target current TC in the entire grayscale value range of the input image data IMG and the protection operation may be operated based on the protection level PL so that the protection performance may be enhanced.

The burn-in occurring in the entire load pattern may be properly detected so that the display apparatus may not be damaged.

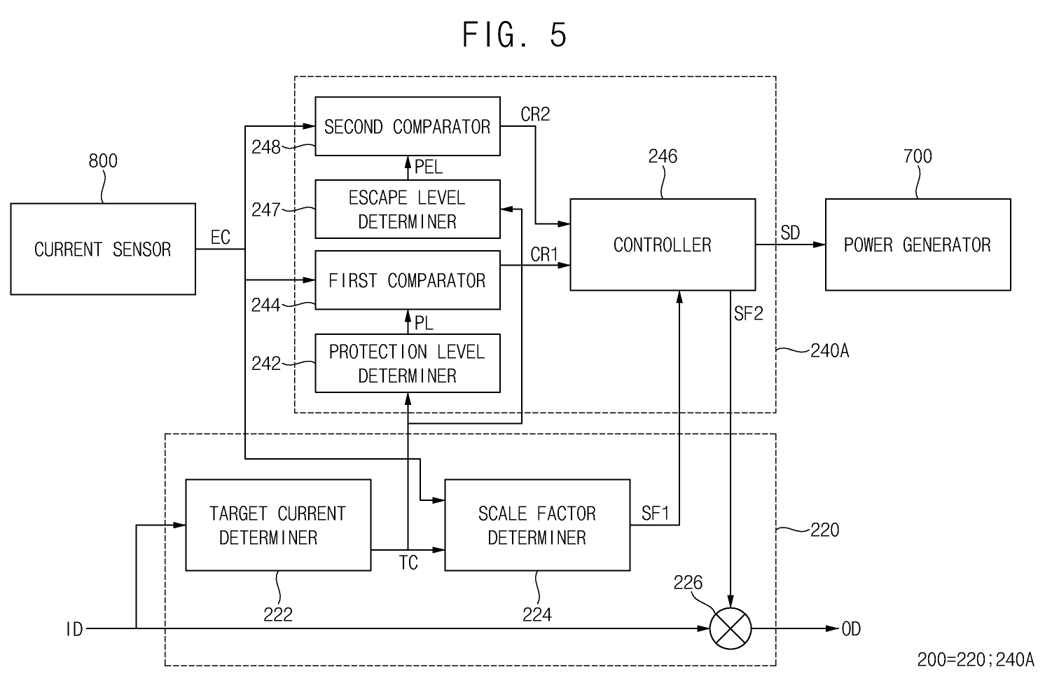

FIG. 5 is a detailed block diagram illustrating a current sensor 800, a driving controller 200 and a power generator 700 of a display apparatus according to an embodiment of the present inventive concept.

The display apparatus according to the present embodiment is substantially the same as the display apparatus of the previous embodiment explained referring to FIGS. 1 - 3 and 4B except for a structure and an operation of the shut down controller. Thus, the same reference numerals will be used to refer to the same or like parts as those described in the previous embodiment of FIGS. 1 - 3 and 4B and any repetitive explanation concerning the above elements will be omitted.

Referring to FIGS. 1, 2, 4B and 5, the driving controller 200 includes a current controller 220 and a shut down controller 240A.

The current controller 220 may receive an input grayscale value ID and a sensed current EC sensed by the current sensor 800 and may output a target current TC and a first scale factor SF1 to the shut down controller 240A.

The current controller 220 may receive a second scale factor SF2 from the shut down controller 240A and may output an output grayscale value OD by applying the second scale factor SF2 to the input grayscale value ID.

The shut down controller 240A may generate a protection level PL corresponding to the target current TC. The shut down controller 240A may generate the second scale factor SF2 based on the first scale factor SF1 and a comparison signal CR1 generated by comparing the protection level PL and the sensed current EC and may output a shut down signal SD based on the comparison signal CR1 and a count signal.

For example, the shut down controller 240A may generate the protection level PL corresponding to the target current TC and a protection escape level PEL corresponding to the target current TC. The shut down controller 240A may generate the second scale factor SF2 based on the first scale factor SF1, the comparison signal CR1 generated by comparing the protection level PL and the sensed current EC and a second comparison signal CR2 generated by comparing the protection escape level PEL and the sensed current EC and may output the shut down signal SD based on the comparison signal CR1, the second comparison signal CR2 and the count signal.

In the present embodiment, the comparison signal CR1 may determine whether to enter the protection mode and the second comparison signal CR2 may determine whether to escape from the protection mode.

For example, the current controller 220 may include a target current determiner 222 generating the target current TC based on the input grayscale value ID.

For example, the current controller 220 may further include a scale factor determiner 224 generating the first scale factor SF1 based on the sensed current EC and the target current TC.

The scale factor determiner 224 may output the first scale factor SF1 to a controller 246 of the shut down controller 240A.

For example, the shut down controller 240A may include a protection level determiner 242 determining the protection level PL based on the target current TC.

For example, the shut down controller 240A may further include a first comparator 244 generating the comparison signal CR1 by comparing the sensed current EC and the protection level PL.

For example, the comparison signal CR1 may have a type of a flag. For example, when the sensed current EC is less than the protection level PL, the comparison signal CR1 may be zero. For example, when the sensed current EC is equal to or greater than the protection level PL, the comparison signal CR1 may be one.

For example, the shut down controller 240A may further include an escape level determiner 247 generating the protection escape level PEL based on the target current TC.

For example, the shut down controller 240A may further include a second comparator 248 generating the second comparison signal CR2 by comparing the sensed current EC and the protection escape level PEL.

For example, the second comparison signal CR2 may have a type of a flag. For example, when the sensed current EC is less than the protection escape level PEL, the second comparison signal CR2 may be one. For example, when the sensed current EC is equal to or greater than the protection escape level PEL, the second comparison signal CR2 may be zero.

The protection escape level PEL may be greater than the target current TC and less than the protection level PL. The protection escape level PEL may be set to be different from the protection level PL so that a stability deterioration of the protection operation due to repeated entry and escape of the protection mode may be prevented

The shut down controller 240A may further include the controller 246 (also referred to as the first controller) generating the second scale factor SF2 based on the comparison signal CR1, the second comparison signal CR2 and the first scale factor SF1.

For example, when the sensed current EC is less than the protection level PL, the display apparatus may operate in a normal mode, not in a protection mode.

For example, when the sensed current EC is equal to or greater than the protection level PL, the display apparatus may enter the protection mode.

When the sensed current EC is less than the protection level PL and equal to or greater than the protection escape level PEL after entering the protection mode, the protection mode of the display apparatus may be maintained.

When the sensed current EC is less than the protection escape level PEL after entering the protection mode, the display apparatus may escape from the protection mode.

When the display apparatus operates the protection mode, the controller 246 may generate the second scale factor SF2 which is less than the first scale factor SF1 and may increase the count signal.

When the display apparatus operates the normal mode, the controller 246 may generate the first scale factor SF1 as the second scale factor SF2 and may initialize the count signal to an initialization value.

In the present embodiment, in the protection mode, the controller 246 does not immediately output the shut down signal SD to the power generator 700.

When entering the protection mode, the controller 246 may accelerate the scaling operation of the current controller 220 so that a current of the display panel 100 may be rapidly reduced and a counting operation which increases the count signal may start.

When the sensed current EC received from the current sensor 800 continues to be equal to or greater than the target current TC for a predetermined time period despite the acceleration of the scaling operation, the controller 246 may output the shut down signal SD to the power controller 700. For example, when the count signal is equal to or greater than a threshold count (corresponding to the predetermined time period), the controller 246 may output the shut down signal SD to the power generator 700.

The current controller 220 may further include a multiplier 226 applying the second scale factor SF2 to the input grayscale value ID to generate the output grayscale value OD.

According to the present embodiment, the protection level PL may be determined based on the target current TC in the entire grayscale value range of the input image data IMG and the protection operation may be operated based on the protection level PL so that the protection performance may be enhanced.

The burn-in occurring in the entire load pattern may be properly detected so that the display apparatus may not be damaged.

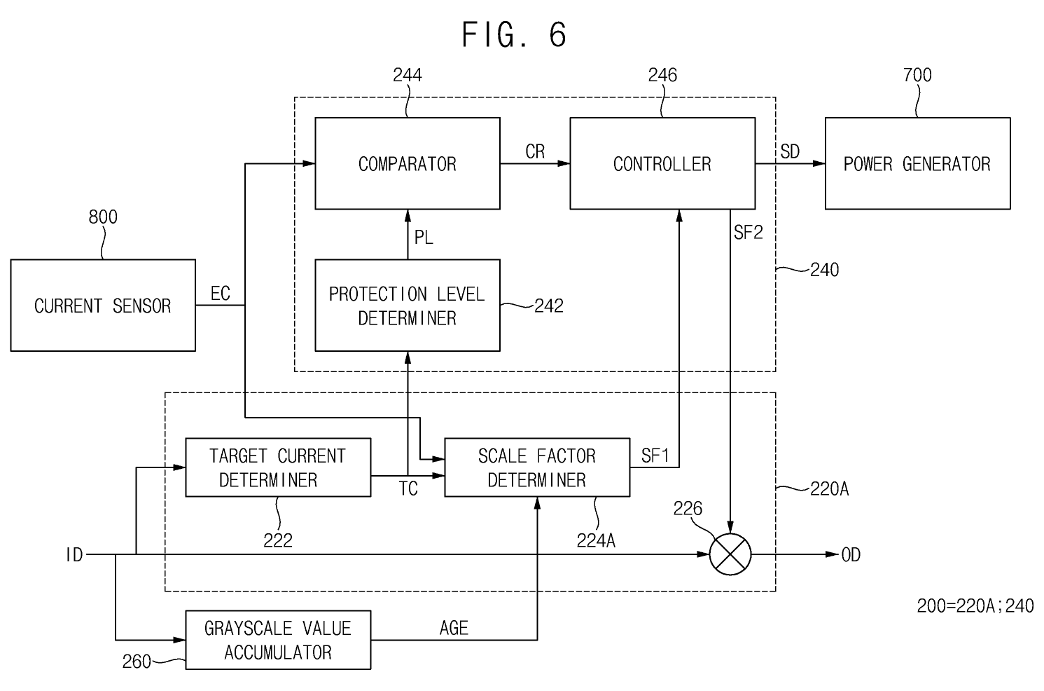

FIG. 6 is a detailed block diagram illustrating a current sensor 800, a driving controller 200 and a power generator 700 of a display apparatus according to an embodiment of the present inventive concept.

The display apparatus according to the present embodiment is substantially the same as the display apparatus of the previous embodiment explained referring to FIGS. 1 - 3 and 4B except that the driving controller further comprises a grayscale value accumulator and the scale factor determiner generates the first scale factor using a grayscale value accumulation signal generated by the grayscale value accumulator. Thus, the same reference numerals will be used to refer to the same or like parts as those described in the previous embodiment of FIGS. 1 - 3 and 4B and any repetitive explanation concerning the above elements will be omitted.

Referring to FIGS. 1, 2, 4B and 6, the driving controller 200 includes a current controller 220A, a shut down controller 240 and a grayscale value accumulator 260.

The grayscale value accumulator 260 may accumulate an input grayscale value ID to generate a grayscale value accumulation signal AGE. The grayscale value accumulator 260 may output the grayscale value accumulation signal AGE to a scale factor determiner 224A of the current controller 220A.

The current controller 220A may receive the input grayscale value ID, the grayscale value accumulation signal AGE and a sensed current EC sensed by the current sensor 800 and may output a target current TC and a first scale factor SF1 to the shut down controller 240.

The current controller 220A may receive a second scale factor SF2 from the shut down controller 240 and may output an output grayscale value OD by applying the second scale factor SF2 to the input grayscale value ID.

The shut down controller 240 may generate a protection level PL corresponding to the target current TC. The shut down controller 240 may generate the second scale factor SF2 based on the first scale factor SF1 and a comparison signal CR generated by comparing the protection level PL and the sensed current EC and may output a shut down signal SD based on the comparison signal CR and a count signal.

For example, the current controller 220A may include a target current determiner 222 generating the target current TC based on the input grayscale value ID.

For example, the current controller 220A may further include a scale factor determiner 224A generating the first scale factor SF1 based on the sensed current EC, the target current TC and the grayscale value accumulation signal AGE.

For example, when the sensed current EC is equal to or less than the target current TC, the scale factor determiner 224A may not operate a scaling operation. For example, when the sensed current EC is equal to or less than the target current TC, the scale factor determiner 224A may generate the first scale factor SF1 of one.

The first scale factor SF1 may be a value between zero and one and the first scale factor SF1 may be used to be multiplied to the input grayscale value ID to generate the output grayscale value OD.

For example, when the sensed current EC is greater than the target current TC, the scale factor determiner 224A may operate the scaling operation. For example, when the sensed current EC is greater than the target current TC, the scale factor determiner 224A may generate the first scale factor SF1 of a value less than one.

In the present embodiment, when a value of the grayscale value accumulation value AGE is less than a predetermined value in a predetermined low grayscale value range, the scale factor determiner 224A may determine the first scale factor SF1 to one. For example, when the value of the grayscale value accumulation value AGE is less than the predetermined value in the low grayscale value range, the scale factor determiner 224A may not operate the scaling operation. A resolution for changing a grayscale value in the low grayscale value range is relatively insufficient so that an abnormal operation such as overcompensation or undercompensation may occur when the scaling operation is operated in the low grayscale value range in the same manner as in a high grayscale value range. For example, the low grayscale value range may be between zero to 32 when a maximum grayscale value is 256. For example, the low grayscale value range may be between zero to 16 when the maximum grayscale value is 256.

However, when a usage time of the display panel 100 increases (when the value of the grayscale accumulation signal AGE increases), a current of the display panel 100 to display the same luminance may increase due to a deterioration compensation operation of the driving controller 200. When the current of the display panel 100 increases due to an increase of the usage time, a current level of the display panel 100 generally increases so that a need for the scaling operation may increase even in the low grayscale value range.

Thus, in the present embodiment, as the value of the grayscale value accumulation signal AGE increases, the scale factor determiner 224A may decrease the first scale factor SF1 of the low grayscale value range. Decreasing the first scale factor SF1 means increasing a degree of scaling.

The first scale factor SF1 of the low grayscale value range and the first scale factor SF1 of a grayscale value range except for the low grayscale value range may be determined as follows.

For example, when the first scale factor SF1 is determined to 0.9 by the sensed current EC and the target current TC and the first scale factor SF1 of the low grayscale value range is determined to one by the grayscale value accumulation signal AGE, the scaling operation may not be operated for the low grayscale value range and the scaling operation may be operated for the grayscale value range except for the low grayscale value range by 0.9.

For example, when the first scale factor SF1 is determined to 0.8 by the sensed current EC and the target current TC and the first scale factor SF1 of the low grayscale value range is determined to one by the grayscale value accumulation signal AGE, the scaling operation may not be operated for the low grayscale value range and the scaling operation may be operated for the grayscale value range except for the low grayscale value range by 0.8.

For example, when the first scale factor SF1 is determined to 0.8 by the sensed current EC and the target current TC and the first scale factor SF1 of the low grayscale value range is determined to 0.9 by the grayscale value accumulation signal AGE, the scaling operation may be operated for the low grayscale value range by 0.9 and the scaling operation may be operated for the grayscale value range except for the low grayscale value range by 0.8.

For example, when the first scale factor SF1 is determined to 0.7 by the sensed current EC and the target current TC and the first scale factor SF1 of the low grayscale value range is determined to 0.9 by the grayscale value accumulation signal AGE, the scaling operation may be operated for the low grayscale value range by 0.9 and the scaling operation may be operated for the grayscale value range except for the low grayscale value range by 0.7.

For example, when the first scale factor SF1 is determined to 0.8 by the sensed current EC and the target current TC and the first scale factor SF1 of the low grayscale value range is determined to 0.8 by the grayscale value accumulation signal AGE, the scaling operation may be operated by 0.8 for both the low grayscale value range and the grayscale value range except for the low grayscale value range.

The scale factor determiner 224A may output the first scale factor SF1 to a controller 246 of the shut down controller 240.

For example, the shut down controller 240 may include a protection level determiner 242 determining the protection level PL based on the target current TC.

For example, the shut down controller 240 may further include a comparator 244 generating the comparison signal CR by comparing the sensed current EC and the protection level PL.

For example, the shut down controller 240 may further include the controller 246 generating the second scale factor SF2 based on the comparison signal CR and the first scale factor SF1.

When the sensed current EC is less than the protection level PL, the controller 246 may generate the first scale factor SF1 as the second scale factor SF2.

When the sensed current EC is equal to or greater than the protection level PL, the controller 246 may generate the second scale factor SF2 which is less than the first scale factor SF1 and may increase the count signal. When the sensed current EC is equal to or greater than the protection level PL, the display apparatus may operate in the protection mode.

In the present embodiment, in the protection mode, the controller 246 does not immediately output the shut down signal SD to the power generator 700.

In the protection mode, the controller 246 lowers the first scale factor SF1 to the second scale factor SF2 and outputs the second scale factor SF2 to the current controller 220A.

When entering the protection mode, the controller 246 may accelerate the scaling operation of the current controller 220A so that a current of the display panel 100 may be rapidly reduced and a counting operation which increases the count signal may start.

When the sensed current EC received from the current sensor 800 continues to be equal to or greater than the target current TC for a predetermined time period despite the acceleration of the scaling operation, the controller 246 may output the shut down signal SD to the power controller 700.

The current controller 220A may further include a multiplier 226 applying the second scale factor SF2 to the input grayscale value ID to generate the output grayscale value OD.

Although the shut down controller of the present embodiment is substantially the same as the shut down controller 240 of FIG. 3, the present inventive concept may not be limited thereto. The shut down controller the present embodiment may be substantially the same as the shut down controller 240A of FIG. 5.

According to the present embodiment, the protection level PL may be determined based on the target current TC in the entire grayscale value range of the input image data IMG and the protection operation may be operated based on the protection level PL so that the protection performance may be enhanced.

The burn-in occurring in the entire load pattern may be properly detected so that the display apparatus may not be damaged.

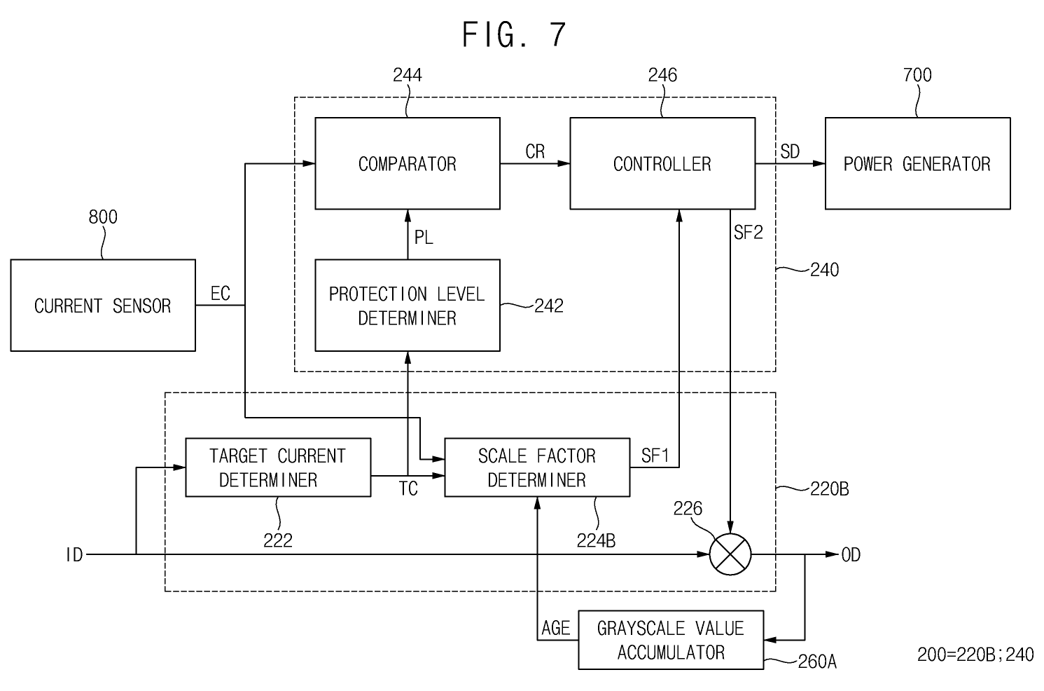

FIG. 7 is a detailed block diagram illustrating a current sensor 800, a driving controller 200 and a power generator 700 of a display apparatus according to an embodiment of the present inventive concept.

The display apparatus according to the present embodiment is substantially the same as the display apparatus of the previous embodiment explained referring to FIGS. 1 - 3 and 4B except that the driving controller further comprises a grayscale value accumulator and the scale factor determiner generates the first scale factor using a grayscale value accumulation signal generated by the grayscale value accumulator. Thus, the same reference numerals will be used to refer to the same or like parts as those described in the previous embodiment of FIGS. 1 - 3 and 4B and any repetitive explanation concerning the above elements will be omitted.

Referring to FIGS. 1, 2, 4B and 7, the driving controller 200 includes a current controller 220B, a shut down controller 240 and a grayscale value accumulator 260A.

The grayscale value accumulator 260A may accumulate an output grayscale value OD to generate a grayscale value accumulation signal AGE. The grayscale value accumulator 260A may output the grayscale value accumulation signal AGE to a scale factor determiner 224B of the current controller 220B.

The current controller 220B may receive an input grayscale value ID, the grayscale value accumulation signal AGE and a sensed current EC sensed by the current sensor 800 and may output a target current TC and a first scale factor SF1 to the shut down controller 240.

The current controller 220B may receive a second scale factor SF2 from the shut down controller 240 and may output the output grayscale value OD by applying the second scale factor SF2 to the input grayscale value ID.

The shut down controller 240 may generate a protection level PL corresponding to the target current TC. The shut down controller 240 may generate the second scale factor SF2 based on the first scale factor SF1 and a comparison signal CR generated by comparing the protection level PL and the sensed current EC and may output a shut down signal SD based on the comparison signal CR and a count signal.

For example, the current controller 220B may include a target current determiner 222 generating the target current TC based on the input grayscale value ID.

For example, the current controller 220B may further include a scale factor determiner 224B generating the first scale factor SF1 based on the sensed current EC, the target current TC and the grayscale value accumulation signal AGE.

For example, when the sensed current EC is equal to or less than the target current TC, the scale factor determiner 224B may not operate a scaling operation. For example, when the sensed current EC is equal to or less than the target current TC, the scale factor determiner 224B may generate the first scale factor SF1 of one.

The first scale factor SF1 may be a value between zero and one and the first scale factor SF1 may be used to be multiplied to the input grayscale value ID to generate the output grayscale value OD.

For example, when the sensed current EC is greater than the target current TC, the scale factor determiner 224B may operate the scaling operation. For example, when the sensed current EC is greater than the target current TC, the scale factor determiner 224B may generate the first scale factor SF1 of a value less than one.

In the present embodiment, when a value of the grayscale value accumulation value AGE is less than a predetermined value in a predetermined low grayscale value range, the scale factor determiner 224B may determine the first scale factor SF1 to one. For example, when the value of the grayscale value accumulation value AGE is less than the predetermined value in the low grayscale value range, the scale factor determiner 224B may not operate the scaling operation. A resolution for changing a grayscale value in the low grayscale value range is relatively insufficient so that an abnormal operation such as overcompensation or undercompensation may occur when the scaling operation is operated in the low grayscale value range in the same manner as in a high grayscale value range. For example, the low grayscale value range may be between zero to 32 when a maximum grayscale value is 256. For example, the low grayscale value range may be between zero to 16 when the maximum grayscale value is 256.

However, when a usage time of the display panel 100 increases (when the value of the grayscale accumulation signal AGE increases), a current of the display panel 100 to display the same luminance may increase due to a deterioration compensation operation of the driving controller 200. When the current of the display panel 100 increases due to an increase of the usage time, a current level of the display panel 100 generally increases so that a need for the scaling operation may increase even in the low grayscale value range.

Thus, in the present embodiment, as the value of the grayscale value accumulation signal AGE increases, the scale factor determiner 224B may decrease the first scale factor SF1 of the low grayscale value range. Decreasing the first scale factor SF1 means increasing a degree of scaling.

The first scale factor SF1 of the low grayscale value range and the first scale factor SF1 of a grayscale value range except for the low grayscale value range may be determined as follows.

For example, when the first scale factor SF1 is determined to 0.9 by the sensed current EC and the target current TC and the first scale factor SF1 of the low grayscale value range is determined to one by the grayscale value accumulation signal AGE, the scaling operation may not be operated for the low grayscale value range and the scaling operation may be operated for the grayscale value range except for the low grayscale value range by 0.9.

For example, when the first scale factor SF1 is determined to 0.8 by the sensed current EC and the target current TC and the first scale factor SF1 of the low grayscale value range is determined to one by the grayscale value accumulation signal AGE, the scaling operation may not be operated for the low grayscale value range and the scaling operation may be operated for the grayscale value range except for the low grayscale value range by 0.8.

For example, when the first scale factor SF1 is determined to 0.8 by the sensed current EC and the target current TC and the first scale factor SF1 of the low grayscale value range is determined to 0.9 by the grayscale value accumulation signal AGE, the scaling operation may be operated for the low grayscale value range by 0.9 and the scaling operation may be operated for the grayscale value range except for the low grayscale value range by 0.8.

For example, when the first scale factor SF1 is determined to 0.7 by the sensed current EC and the target current TC and the first scale factor SF1 of the low grayscale value range is determined to 0.9 by the grayscale value accumulation signal AGE, the scaling operation may be operated for the low grayscale value range by 0.9 and the scaling operation may be operated for the grayscale value range except for the low grayscale value range by 0.7.

For example, when the first scale factor SF1 is determined to 0.8 by the sensed current EC and the target current TC and the first scale factor SF1 of the low grayscale value range is determined to 0.8 by the grayscale value accumulation signal AGE, the scaling operation may be operated by 0.8 for both the low grayscale value range and the grayscale value range except for the low grayscale value range.

The scale factor determiner 224B may output the first scale factor SF1 to a controller 246 of the shut down controller 240.

For example, the shut down controller 240 may include a protection level determiner 242 determining the protection level PL based on the target current TC.

For example, the shut down controller 240 may further include a comparator 244 generating the comparison signal CR by comparing the sensed current EC and the protection level PL.

For example, the shut down controller 240 may further include the controller 246 generating the second scale factor SF2 based on the comparison signal CR and the first scale factor SF1.

When the sensed current EC is less than the protection level PL, the controller 246 may generate the first scale factor SF1 as the second scale factor SF2.

When the sensed current EC is equal to or greater than the protection level PL, the controller 246 may generate the second scale factor SF2 which is less than the first scale factor SF1 and may increase the count signal. When the sensed current EC is equal to or greater than the protection level PL, the display apparatus may operate in the protection mode.

In the present embodiment, in the protection mode, the controller 246 does not immediately output the shut down signal SD to the power generator 700.

In the protection mode, the controller 246 lowers the first scale factor SF1 to the second scale factor SF2 and outputs the second scale factor SF2 to the current controller 220B.

When entering the protection mode, the controller 246 may accelerate the scaling operation of the current controller 220B so that a current of the display panel 100 may be rapidly reduced and a counting operation which increases the count signal may start.

When the sensed current EC received from the current sensor 800 continues to be equal to or greater than the target current TC for a predetermined time period despite the acceleration of the scaling operation, the controller 246 may output the shut down signal SD to the power controller 700.

The current controller 220B may further include a multiplier 226 applying the second scale factor SF2 to the input grayscale value ID to generate the output grayscale value OD.

Although the shut down controller of the present embodiment is substantially the same as the shut down controller 240 of FIG. 3, the present inventive concept may not be limited thereto. In an embodiment the shut down controller may be substantially the same as the shut down controller 240A of FIG. 5.

According to the present embodiment, the protection level PL may be determined based on the target current TC in the entire grayscale value range of the input image data IMG and the protection operation may be operated based on the protection level PL so that the protection performance may be enhanced.

The burn-in occurring in the entire load pattern may be properly detected so that the display apparatus may not be damaged.

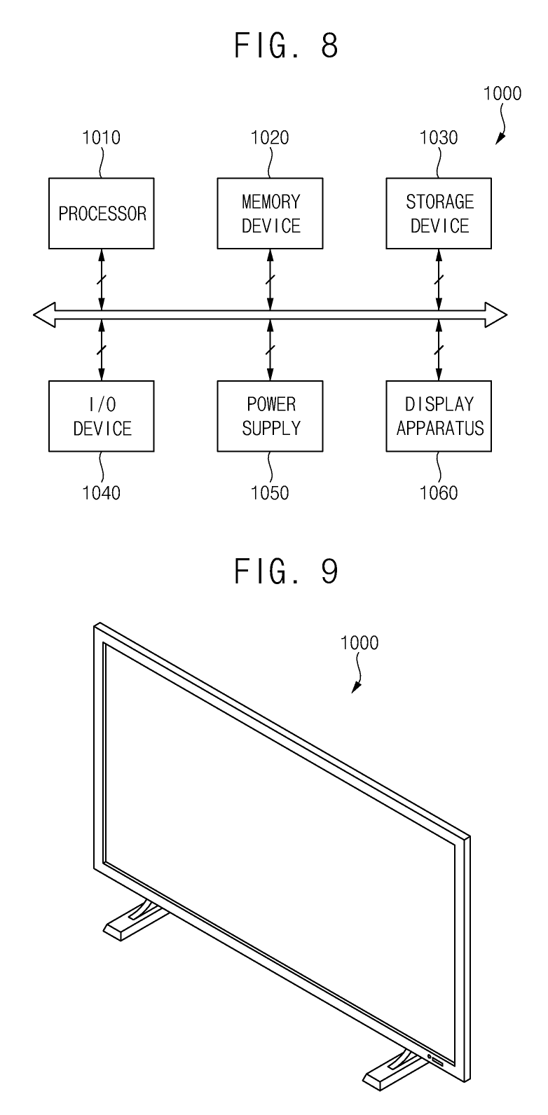

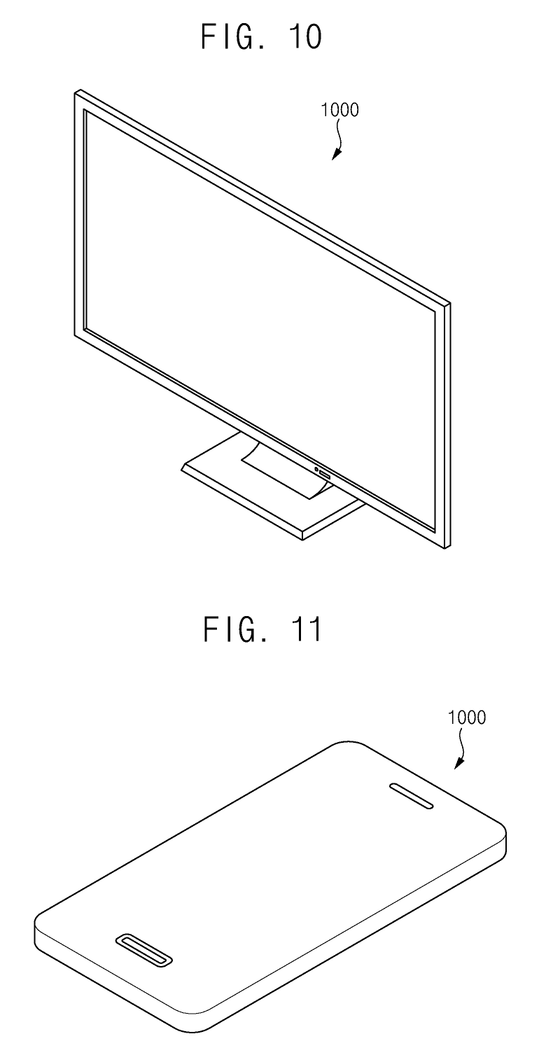

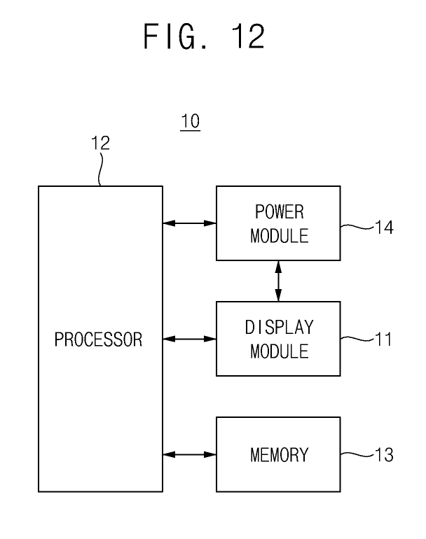

FIG. 8 is a block diagram illustrating an electronic apparatus 1000 according to an embodiment of the present inventive concept. FIG. 9 is a diagram illustrating an example in which the electronic apparatus of FIG. 8 is implemented as a television. FIG. 10 is a diagram illustrating an example in which the electronic apparatus of FIG. 8 is implemented as a monitor. FIG. 11 is a diagram illustrating an example in which the electronic apparatus of FIG. 8 is implemented as a smartphone.

Referring to FIGS. 8 - 11, the electronic apparatus 1000 may include a processor 1010, a memory device 1020, a storage device 1030, an input/output (I/O) device 1040, a power supply 1050, and a display apparatus 1060. Here, the display apparatus 1060 may be the display apparatus of FIG. 1. Here, the processor 1010 may be the processor 600 of FIG. 1. In addition, the electronic apparatus 1000 may further include a plurality of ports for communicating with a video card, a sound card, a memory card, a universal serial bus (USB) device, other electronic apparatuses, etc.

In an embodiment, as illustrated in FIG. 9, the electronic apparatus 1000 may be implemented as a television. As illustrated in FIG. 10, the electronic apparatus 1000 may be implemented as a monitor. As illustrated in FIG. 11, the electronic apparatus 1000 may be implemented as a smartphone. However, the electronic apparatus 1000 is not limited thereto. For example, the electronic apparatus 1000 may be implemented as a cellular phone, a video phone, a smart pad, a smart watch, a tablet PC, a car navigation system, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus. The processor 1010 may include one or more processors. In implementations with more than one processor, the processors may work individually, collectively or as part of a collective. For example, as part of a collective two out of three processors may operate together to execute instructions for an application.

The processor 1010 may output the input image data IMG and the input control signal CONT to the driving controller 200 of FIG. 1.

The memory device 1020 may store data for operations of the electronic apparatus 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

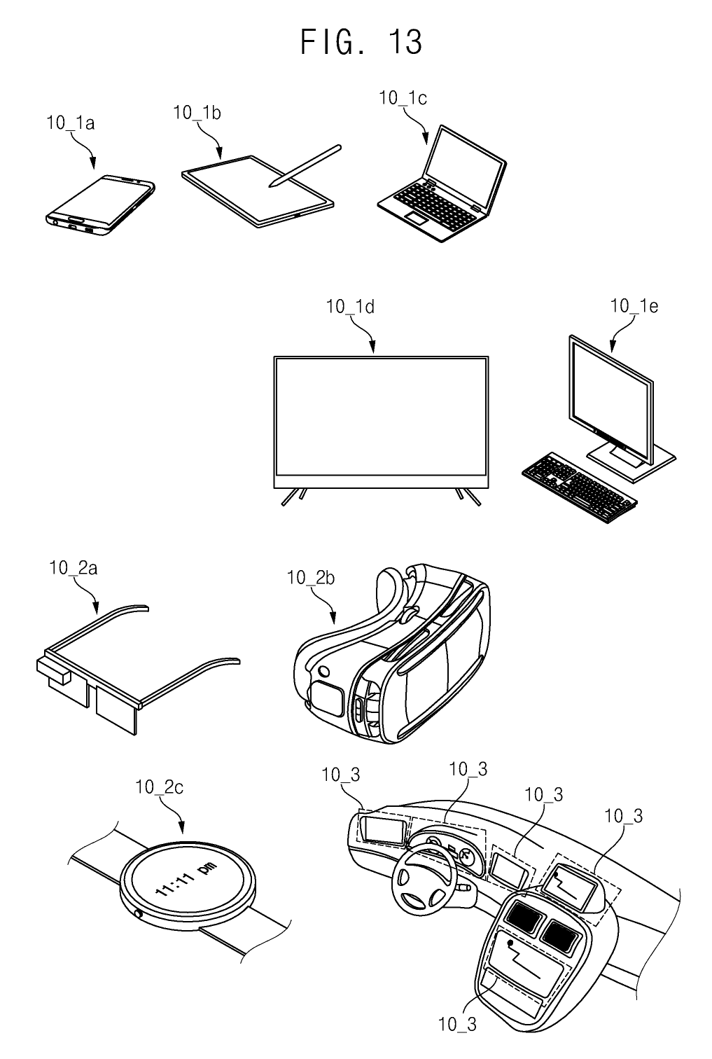

FIG. 12 is a block diagram illustrating an electronic apparatus 10 according to an embodiment of the present inventive concept. FIG. 13 is schematic diagrams illustrating the electronic apparatuses 10 of FIG. 12.

Referring to FIG. 12, the electronic apparatus 10 according to an embodiment may include a display module 11, a processor 12, a memory 13 and a power module 14.

The display apparatus according to the embodiment of the present inventive concept may be applied to various electronic apparatuses.

In an embodiment, the electronic apparatus 10 may include the display apparatus of FIG. 1. An operation of the display apparatus included in the electronic apparatus 10 may be the same as the operation of the display apparatus explained referring to FIGS. 1 - 7. The electronic apparatus 10 may further include a module or an apparatus having additional functions in addition to the display apparatus.

The processor 12 may include at least one of a central processing unit (CPU), an application processor (AP), a graphic processing unit (GPU), a communication processor (CP), an image signal processor (ISP) and a controller. The processor 12 may include one or more processors. In implementations with more than one processor, the processors may work individually, collectively or as part of a collective. For example, as part of a collective two out of three processors may operate together to execute instructions for an application.

In an embodiment, the processor 12 may provide the input control signal CONT of FIG. 1 and the input image data IMG of FIG. 1 to the driving controller 200 included in the display apparatus of FIG. 1.

In an embodiment, the processor 12 may be divided into two or more in a functional or structural perspective. For example, the processor 12 may include a main processor, which is a first driving chip type, including the central processing unit and an auxiliary processor, which is a second driving chip type, including a controller receiving an image signal from the main processor and processing the image signal to match interface specifications of the display module 11. For example, the auxiliary processor may include the driving controller 200 included in the display apparatus of FIG. 1. Thus, the main processor may provide the input control signal CONT of the FIG. 1 and the input image data IMG of FIG. 1 to the auxiliary processor. The auxiliary processor may process the image signal based on the input control signal CONT and the input image data IMG.

The memory 13 may include at least one of a nonvolatile memory and a volatile memory. Data information for the operation of the processor 12 or the display module 11 may be stored in the memory 13. When the processor 12 executes an application stored in the memory 13, the input control signal CONT and/or the input image data IMG may be transmitted to the display module 11 and the display module 11 may process the input control signal CONT and/or the input image data IMG and may output image information through a display area.

The power module 14 may include a power supply module, such as a power adapter or a battery device, and a power conversion module converting power supplied by the power supply module to generate a power for the operation of the electronic apparatus 10.

At least one of the elements of the electronic apparatus 10 may be included in the display apparatus according to embodiments of the present inventive concept. In addition, a part of a single functional module may be included in the display apparatus and another part of the single functional module may be disposed outside of the display apparatus. For example, the display module 11 may be included in the display apparatus but the processor 12, the memory 13 and the power module 14 may be included in another apparatus in the electronic apparatus 10 which is not the display apparatus.

Referring to FIG. 3, the various electronic apparatuses including the display apparatus according to the present embodiments may include electronic apparatuses for displaying image such as a smartphone 10_1a, a tablet PC 10_1b, a laptop 10_1c, a television 10_1d, a desktop monitor 10_1e, wearable electronic apparatuses including a display module such as smart glasses 10_2a, a head mounted display 10_2b and a smart watch 10_2c and vehicle electronic apparatuses 10_3 including display modules such as a CID (center information display), a room mirror display disposed on an instrument panel, center fascia, and a dashboard of a vehicle. The electronic apparatus 10 may not be limited to the electronic apparatuses for displaying image, the wearable electronic apparatuses and the vehicle electronic apparatuses 10_3.

According to the display apparatus and the electronic apparatus including the display apparatus of the present embodiment as explained above, the protection level may be determined based on the target current in the entire grayscale value range of the input image data and the protection operation may be operated based on the protection level so that the protection performance may be enhanced.

The foregoing is illustrative of the present inventive concept and is not to be construed as limiting thereof. Although a few example embodiments of the present inventive concept have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific example embodiments disclosed, and that modifications to the disclosed example embodiments, as well as other example embodiments, are intended to be included within the scope of the appended claims. The present inventive concept is defined by the following claims, with equivalents of the claims to be included therein.

What is claimed is:

1. A display apparatus comprising:
a display panel;
a data driver configured to output a data voltage to the display panel;
a power generator configured to output a power voltage to the display panel or the data driver;
a driving controller configured to control the data driver and the power generator and the driving controller comprising a current controller and a shut down controller; and
a current sensor configured to sense a current of the display panel,
wherein the current controller is configured to receive an input grayscale value and a sensed current sensed by the current sensor, and output a target current and a first scale factor to the shut down controller, and receive a second scale factor from the shut down controller and output an output grayscale value by applying the second scale factor to the input grayscale value, and
wherein the shut down controller is configured to generate a protection level corresponding to the target current, and generate the second scale factor based on the first scale factor and a comparison signal generated by comparing the protection level and the sensed current, and output a shut down signal based on the comparison signal and a count signal.

2. The display apparatus of claim 1, wherein the current controller comprises a target current determiner configured to generate the target current based on the input grayscale value.

3. The display apparatus of claim 2, wherein the current controller further comprises a scale factor determiner configured to generate the first scale factor based on the sensed current and the target current.

4. The display apparatus of claim 3, wherein the shut down controller comprises a protection level determiner configured to determine the protection level based on the target current.

5. The display apparatus of claim 4, wherein the protection level is determined by multiplying the target current by a first constant and adding a black overcurrent protection level.

6. The display apparatus of claim 4, wherein the shut down controller further comprises a comparator configured to generate the comparison signal by comparing the sensed current and the protection level.

7. The display apparatus of claim 6, wherein the shut down controller further comprises a first controller configured to generate the second scale factor based on the comparison signal and the first scale factor.

8. The display apparatus of claim 7, wherein when the sensed current is less than the protection level, the controller is configured to generate the first scale factor as the second scale factor.

9. The display apparatus of claim 7, wherein the first controller is configured to generate the second scale factor which is less than the first scale factor and increase the count signal when the sensed current is equal to or greater than the protection level.

10. The display apparatus of claim 9, wherein the first controller is configured to output the shut down signal to the power generator when the count signal is equal to or greater than a threshold count.

11. The display apparatus of claim 7, wherein the current controller further comprises a multiplier configured to apply the second scale factor to the input grayscale value to generate the output grayscale value.

12. The display apparatus of claim 6, wherein the shut down controller further comprises an escape level determiner configured to generate a protection escape level based on the target current.

13. The display apparatus of claim 12, wherein the protection escape level is greater than the target current and less than the protection level.

14. The display apparatus of claim 12, wherein the shut down controller further comprises a second comparator configured to generate a second comparison signal by comparing the sensed current and the protection escape level.

15. The display apparatus of claim 14, wherein the shut down controller further comprises the first controller configured to generate the second scale factor based on the comparison signal, the second comparison signal and the first scale factor.

16. The display apparatus of claim 15, wherein the display apparatus is configured to enter a protection mode when the sensed current is equal to or greater than the protection level,
wherein the protection mode of the display apparatus is maintained when the sensed current is less than the protection level and equal to or greater than the protection escape level after entering the protection mode, and
wherein the display apparatus is configured to escape from the protection mode when the sensed current is less than the protection escape level after entering the protection mode.

17. The display apparatus of claim 16, wherein when the display apparatus operates in the protection mode, the controller is configured to generate the second scale factor which is less than the first scale factor and increase the count signal, and
wherein when the display apparatus operates in a normal mode which is not the protection mode, the controller is configured to generate the first scale factor as the second scale factor and to initialize the count signal to an initialization value.

18. The display apparatus of claim 3, wherein the driving controller further comprises a grayscale value accumulator configured to accumulate the input grayscale value to generate a grayscale value accumulation signal, and
wherein as a value of the grayscale value accumulation signal increases, the scale factor determiner is configured to decrease the first scale factor of a low grayscale value range.

19. The display apparatus of claim 3, wherein the driving controller further comprises a grayscale value accumulator configured to accumulate the output grayscale value to generate a grayscale value accumulation signal, and
wherein as a value of the grayscale value accumulation signal increases, the scale factor determiner is configured to decrease the first scale factor of a low grayscale value range.

20. An electronic apparatus comprising:
a display panel;
a data driver configured to output a data voltage to the display panel;
a power generator configured to output a power voltage to the display panel or the data driver;
a driving controller configured to control the data driver and the power generator and comprising a current controller and a shut down controller;
a current sensor configured to sense a current of the display panel; and
one or more processors configured to output input image data and an input control signal to the driving controller,
wherein the current controller is configured to receive an input grayscale value and a sensed current sensed by the current sensor, and output a target current and a first scale factor to the shut down controller, and receive a second scale factor from the shut down controller and output an output grayscale value by applying the second scale factor to the input grayscale value,
wherein the shut down controller is configured to generate a protection level corresponding to the target current, and generate the second scale factor based on the first scale factor and a comparison signal generated by comparing the protection level and the sensed current, and output a shut down signal based on the comparison signal and a count signal.
